(19) United States
(12) Patent Application Publication
(10) Pub. No.: US 2021/0375300 A1
(43) Pub. Date: Dec. 2, 2021

(54) SPEECH INTELLIGIBILITY CALCULATING METHOD, SPEECH INTELLIGIBILITY CALCULATING APPARATUS, AND SPEECH INTELLIGIBILITY CALCULATING PROGRAM

(71) Applicants: NIPPON TELEGRAPH AND TELEPHONE CORPORATION, Tokyo (JP); Wakayama University, Wakayama (JP)

(72) Inventors: Shoko ARAKI, Soraku-gun, Kyoto (JP); Tomohiro NAKATANI, Soraku-gun, Kyoto (JP); Keisuke KINOSHITA, Soraku-gun, Kyoto (JP); Toshio IRINO, Wakayama (JP); Toshie MATSUI, Wakayama (JP); Katsuhiko YAMAMOTO, Wakayama (JP)

(73) Assignees: NIPPON TELEGRAPH AND TELEPHONE CORPORATION, Tokyo (JP); Wakayama University, Wakayama (JP)

(21) Appl. No.: 16/636,032

(22) PCT Filed: Aug. 3, 2018
(86) PCT No.: PCT/JP2018/029317

§ 371 Date: Feb. 3, 2020

(30) Foreign Application Priority Data
Aug. 4, 2017 (JP) 2017-151370

(51) Int. Cl. G10L 21/0232; G10L 21/0364; G10L 25/60

(52) U.S. Cl. CPC G10L 21/0232; G10L 25/60; G10L 21/0364

(57) ABSTRACT

A speech intelligibility calculating method is a method executed by a speech intelligibility calculating apparatus, the speech intelligibility calculating method including: a speech intelligibility calculating step of calculating a speech intelligibility that is an objective assessment index of a speech quality, based on a difference component between features found through an analysis of an input clean speech and an input enhanced speech, using one or more filter banks; and a step of outputting the speech intelligibility calculated at the speech intelligibility calculating step. This speech intelligibility calculating method is capable of calculating a speech intelligibility without any dependency on a speech enhancement method.

### FIELD

The present invention relates to a speech intelligibility calculating method, a speech intelligibility calculating apparatus, and a speech intelligibility calculating program.

### BACKGROUND

A speech intelligibility or an objective speech-quality assessment index is essential for the future development of a speech enhancement or noise-reduction signal processing, and making improvements in these types of processing. In other words, there has been a demand for obtaining a speech intelligibility, which is one example of the objective speech-quality assessment index, for the purpose of making an assessment and an improvement of the speech enhancement processing, such as noise reduction processing.

Addressing this issue, conventionally, a speech-based envelope power spectrum model (sEPSM) has been disclosed (see Non Patent Literature 1, for example). FIG. 8 is a schematic illustrating the framework of a conventional speech intelligibility prediction. Hereinafter, it is assumed that, for a signal A, the indication “\hat{ }A” is equivalent to the symbol “\hat{ }” appended immediately above “A”, and for the signal A, the indication “˜A” is equivalent to the symbol “˜” appended immediately above “A”.

As illustrated in FIG. 8, conventionally, a speech intelligibility calculating apparatus 12P using the sEPSM receives inputs of an enhanced speech (\hat{ }S) and a residual noise (˜N) from an enhancement processing apparatus 11P. The enhancement processing apparatus 11P positioned at the preceding stage applies enhancement processing to a noisy speech (S+N) that is resultant of adding a noise (N) to a clean speech (S), and also applies the enhancement processing to the noise (N). In other words, the enhancement processing apparatus 11P is configured to output an enhanced speech (\hat{ }S) from the noisy speech (S+N), and to estimate a residual noise (˜N) included in the enhanced speech (\hat{ }S). The speech intelligibility calculating apparatus 12P positioned at the subsequent stage receives the enhanced speech (\hat{ }S) and the residual noise (˜N) output from the enhancement processing apparatus 11P, and predicts an intelligibility of the speech applied with non-linear speech enhancement processing, using a combination of a gammatone (GT) auditory filter bank, which is a mathematical model of a peripheral auditory system, and a modulation filter bank.

Also having been disclosed conventionally is dcGC-sEPSM that uses the dynamic compressive gammachirp filter bank (dcGC) capable of dynamically reflecting non-linear features of auditory filters, instead of the gammatone auditory filter bank used in the sEPSM (see Non Patent Literatures 2 and 3, for example). With this technology, it has become possible to reflect the features of hearing-impaired persons.

### CITATION LIST

### Patent Literature

Non Patent Literature 1: S. Jorgensen, and T. Dau, “Predicting speech intelligibility based on the signal-to-noise envelope power ratio after modulation-frequency selective processing”, J. Acoust. Soc. Am., 130(3), pp. 1475-1487, 2011.

Non Patent Literature 2: K. Yamamoto, T. Irino, T. Matsui, S. Araki, K. Kinoshita, and T. Nakatani, “Speech intelligibility prediction based on the envelope power spectrum model with the dynamic compressive gammachirp auditory filterbank”, in Proceedings of Interspeech 2016, pp. 2885-2889, 2016.

Non Patent Literature 3: Katsuhiko Yamamoto, Toshio Irino, Toshie Matsui, Shoko Araki, Kinoshita Keisuke, and Tomohiro Nakatani, “ONSEI MEIRYOU-DO YOSOKU HOU dcGC-sEPSM NO SYOKENTOU: HYOUKA-YOU ZATSUON NO TOKUSEI TO YOSOKU SEIDO E NO EIKYOU”, Acoustical Society of Japan: KENKYU HAPPYOUKAI KOEN RONBUN SYU, 2-P-44, pp. 663-666, 2016.

### SUMMARY

### Technical Problem

The sEPSM uses a residual noise component (the residual noise (˜N) illustrated in FIG. 5) as an input signal. However, conventionally, a clear definition of the residual component has not been necessarily available, and it has also been necessary to determine a residual component that is appropriate for the assessment, depending on the technique used for the speech enhancement processing. Therefore, the sEPSM has been only capable of estimating an intelligibility for the speech enhancement techniques capable of estimating both of the enhanced speech and the residual noise component, and hence, the applicable scope of the sEPSM has been limited.

Furthermore, because the sEPSM uses linear time-invariant filters for the gammatone auditory filter bank, the sEPSM is incapable of simulating the non-linearity of the peripheral auditory system. Therefore, the sEPSM is incapable of reflecting features of peripheral auditory systems of hearing-impaired persons with various degrees of non-linear impairments. Hence, it has been difficult to use the sEPSM for the speech enhancement/noise reduction signal processing that is intended for hearing aids, disadvantageously.

The dcGC-sEPSM, too, uses a residual noise component (the residual noise (˜N) illustrated in FIG. 5) as an input signal, in the same manner as the sEPSM. Therefore, the dcGC-sEPSM is also only capable of calculating an intelligibility for a speech enhancement technique capable of estimating both of the enhanced speech and the residual noise component, and the applicable scope of the dcGC-sEPSM has been limited.

The present invention is made in consideration of the above, and an object of the present invention is to provide a speech intelligibility calculating method, a speech intelligibility calculating apparatus, and a speech intelligibility calculating program capable of estimating a speech intelligibility highly accurately, without any dependency on a speech enhancement method.

### SOLUTION TO PROBLEM

To address the issue and to achieve the objective described above, a speech intelligibility calculating method according to the present invention is a speech intelligibility calculating method executed by a speech intelligibility calculating apparatus, the speech intelligibility calculating method includes: a speech intelligibility calculating step of finding a feature of a distortion component that is a difference between a temporal amplitude envelope signal that is a feature of an input clean speech and a temporal amplitude envelope signal that is a feature of an enhanced speech, using a plurality of filter banks, and of calculating a speech intelligibility that is an objective assessment index of a speech quality based on the found difference component between the feature of the clean speech and the feature of the distortion component; and a step of outputting the speech intelligibility calculated at the speech intelligibility calculating step.

### Advantageous Effects of Invention

According to the present invention, it is possible to calculate a speech intelligibility without any dependency on a speech enhancement method.

### BRIEF DESCRIPTION OF DRAWINGS

FIG. 1 is a schematic for generally illustrating a system including a gammachirp envelope distortion index (GEDI) speech intelligibility calculating apparatus according to an embodiment.

FIG. 2 is a schematic giving a schematic representation of functions of the GEDI speech intelligibility calculating apparatus illustrated in FIG. 1.

FIG. 3 is a flowchart illustrating the sequence of a speech intelligibility calculating process according to the embodiment.

FIG. 4 is a schematic illustrating results of a listening experiment and prediction results of the GEDI speech intelligibility prediction method.

FIG. 5 is a schematic giving a schematic representation of functions of the GEDI speech intelligibility calculating apparatus according to a second modification of the embodiment.

FIG. 6 is a flowchart illustrating the sequence of a speech intelligibility calculating process according to the second modification of the embodiment.

FIG. 7 is a schematic illustrating one example of a computer implementing the GEDI speech intelligibility calculating apparatus, by executing a computer program.

FIG. 8 is a schematic illustrating the framework of a conventional speech intelligibility prediction.

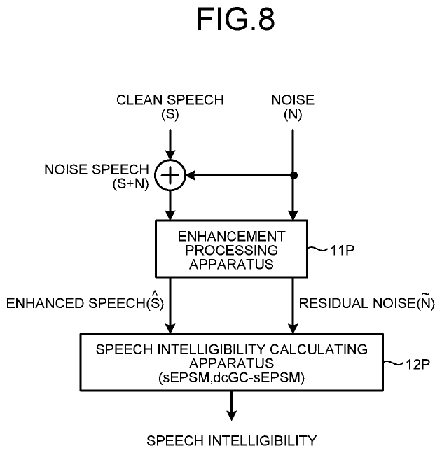

### DESCRIPTION OF EMBODIMENTS

One embodiment of the present invention will now be explained in detail with reference to some drawings. The embodiment is, however, not intended to limit the scope of the present invention in any way. In the descriptions of the drawings, the same parts are illustrated using the same reference signs.

[Embodiment]

An embodiment of the present invention will now be explained. In the embodiment of the present invention, a GEDI speech intelligibility calculating apparatus that uses a GEDI technique will be explained.

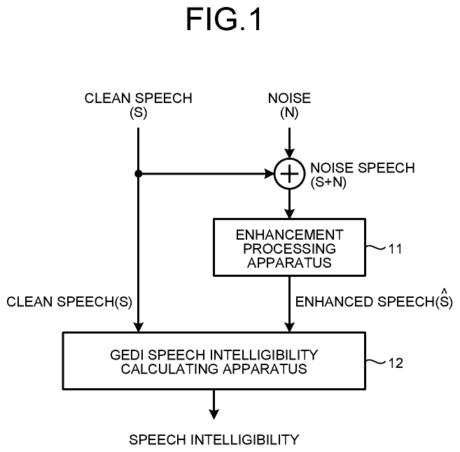

To begin with, a configuration of the speech intelligibility calculating apparatus according to the embodiment will be explained. FIG. 1 is a schematic for generally illustrating a system including the GEDI speech intelligibility calculating apparatus according to the embodiment. This GEDI speech intelligibility calculating apparatus 12 according to the embodiment receives an input of an enhanced speech (\hat{ }S) from an enhancement processing apparatus 11 and an input of a clean speech (S), and outputs a speech intelligibility that is an objective assessment index of a speech quality.

The enhancement processing apparatus 11 applies speech enhancement to a noisy speech (S+N) that is a result of adding a noise (N) to the clean speech (S), and outputs an enhanced speech (\hat{ }S) corresponding to the noisy speech (S+N) to the GEDI speech intelligibility calculating apparatus 12. The clean speech (S) is an original speech signal before the noise superimposition. The GEDI speech intelligibility calculating apparatus 12 that is at the stage subsequent to the enhancement processing apparatus 11 also receives an input of the clean speech (S) before the noise superimposition. In this manner, because it is not necessary for the enhancement processing apparatus 11 to calculate a residual noise component and to input the residual noise component to the GEDI speech intelligibility calculating apparatus 12, it is possible to use any speech enhancement technique, including those having a difficulty in calculating a residual noise component.

The GEDI speech intelligibility calculating apparatus 12 receives inputs of the noisy speech or the enhanced speech (\hat{ }S) for which a speech intelligibility is to be predicted, and the clean speech (S). The GEDI speech intelligibility calculating apparatus 12 finds a feature of a distortion component (D) that is a difference between a temporal amplitude envelope signal that is a feature of the input clean speech and an amplitude envelope signal that is a feature of the enhanced speech, using a plurality of filter banks, and calculates a speech intelligibility based on a difference between the found feature of the clean speech and the feature of the distortion component. The GEDI speech intelligibility calculating apparatus 12 then outputs the speech intelligibility having been calculated correspondingly to the input signals. The GEDI speech intelligibility calculating apparatus 12 estimates the distortion component (D) included in the enhanced speech from the temporal amplitude envelope signal of the clean speech (S) and the temporal amplitude envelope signal of the enhanced speech (\hat{ }S), and then calculates the speech intelligibility. The GEDI speech intelligibility calculating apparatus 12 calculates signal-to-distortion ratio of envelope (SDRₑₙᵥ), which is used as the basis for calculating a speech intelligibility, from the temporal amplitude envelope signal of the clean speech (S) and the temporal amplitude envelope signal of the enhanced speech (\hat{ }S). As steps for calculating a speech intelligibility, the GEDI speech intelligibility calculating apparatus 12 performs a step of finding a temporal distortion signal based on the amplitude envelope signal of the clean speech and the amplitude envelope signal of the enhanced speech, and a step of calculating a signal-to-distortion ratio (SDR) that is a difference component between the clean speech and the distortion signal, based on the feature of the distortion signal and the feature of the clean speech. Specifically, as the steps for calculating a speech intelligibility, the GEDI speech intelligibility calculating apparatus 12 performs a step of finding a temporal distortion signal based on the amplitude envelope signal of the clean speech and the amplitude envelope signal of the enhanced speech, a step of calculating a signal-to-distortion ratio (SDR) that is a difference component between the clean speech and the distortion signal, based on the feature of the distortion signal and the feature of the clean speech, and a step of calculating a speech intelligibility that is an objective assessment index of a speech quality, based on the difference component.

The GEDI speech intelligibility calculating apparatus 12 performs a frequency analysis of the input signals using a dynamic compressive gammachirp (dcGC) filter bank, and performs a filter bank analysis of the resultant amplitude envelopes using a band-pass filter bank in a modulation frequency domain. With the use of the dynamic compressive gammachirp (dcGC) filter bank, the GEDI speech intelligibility calculating apparatus 12 makes it possible to reflect features of hearing-impaired persons, as well as features of hearing persons, and to make an accurate prediction of the intelligibility of an enhanced speech.

[Functional Configuration of GEDI Speech Intelligibility Calculating Apparatus]

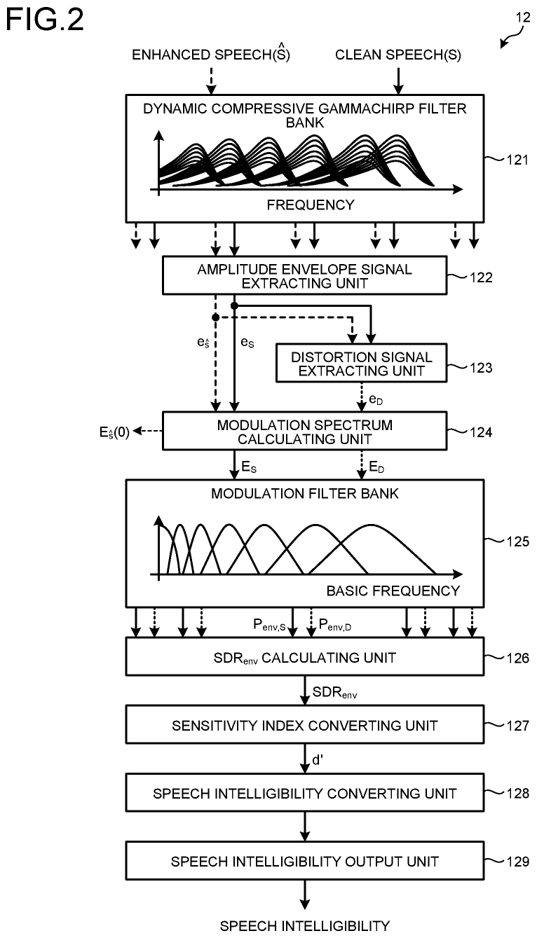

The GEDI speech intelligibility calculating apparatus 12 will now be explained. FIG. 2 is a schematic giving a schematic representation of functions of the GEDI speech intelligibility calculating apparatus 12 illustrated in FIG. 1.

As illustrated in FIG. 2, the GEDI speech intelligibility calculating apparatus 12 is implemented on a general-purpose computer, such as a work station or a personal computer, and, by causing a processor such as a central processing unit (CPU) to execute a processing program stored in a memory, functions as a dynamic compressive gammachirp filter bank 121 (first filter bank), an amplitude envelope signal extracting unit 122, a distortion signal extracting unit 123, a modulation spectrum calculating unit 124, a modulation filter bank 125 (second filter bank), an SDRₑₙᵥ calculating unit 126, a sensitivity index converting unit 127, a speech intelligibility converting unit 128, and a speech intelligibility output unit 129, as illustrated in FIG. 2. Although not illustrated, the GEDI speech intelligibility calculating apparatus 12 also includes an input unit for receiving inputs of an enhanced speech (\hat{ }S) and a clean speech (S), and outputting the enhanced speech (\hat{ }S) and the clean speech (S) to the dynamic compressive gammachirp filter bank 121.

The dynamic compressive gammachirp filter bank 121 receives inputs of an enhanced speech (\hat{ }S) and a clean speech (S), and outputs information of the amplitude envelopes of the enhanced speech (\hat{ }S) and of the clean speech (S). The dynamic compressive gammachirp filter bank 121 includes “I” channels of gammachirp auditory filters in total. The dynamic compressive gammachirp filter bank 121 performs a frequency analysis of the input signals using each one of the “I” channels in total. The dynamic compressive gammachirp filter bank 121 then outputs the signal having passed the dynamic compressive gammachirp filter at the corresponding channel, as a response time signal corresponding to that bandwidth. The dynamic compressive gammachirp filter bank 121 outputs “I” time signals corresponding to the noisy speech or the enhanced speech, and “I” time signals corresponding to the clean speech.

Using the amplitude envelope information output from the filter bank, the amplitude envelope signal extracting unit 122 calculates a temporal amplitude envelope signal of the feature of the clean speech and a temporal amplitude envelope signal of the feature of the noisy speech or the enhanced speech. The amplitude envelope signal extracting unit 122 calculates the temporal amplitude envelope signal by performing a Hilbert transform of the i^{th} channel output from the dynamic compressive gammachirp filter bank 121, and applying a lowpass filter having a cutoff frequency at 150 Hz. In this manner, the amplitude envelope signal extracting unit 122 outputs an amplitude envelope signal (e_{\hat{ }S, i} (n)) corresponding to the noisy speech, and an amplitude envelope signal (e_{s, i} (n)) corresponding to the clean speech, where “n” is the number of samples of the amplitude envelope signals.

Based on a difference between the temporal amplitude envelope signal representing the feature of the clean speech and the temporal amplitude envelope signal representing the feature of the noisy speech or the enhanced speech, the temporal amplitude envelope signals being calculated by the amplitude envelope signal extracting unit 122 based on the outputs of the filter bank, the distortion signal extracting unit 123 extracts a temporal distortion signal. The distortion signal extracting unit 123 receives the amplitude envelope signal (e_{\hat{ }S, i} (n)) corresponding to the noisy speech or the enhanced speech and the amplitude envelope signal (e_{s, i} (n)) corresponding to the clean speech, these amplitude envelope signals being output from the amplitude envelope signal extracting unit 122, and calculates a temporal distortion signal (e_{D}) to be found from both of these signals using Equation (1) below.

$${e}_{D , i} ( n ) = {( \vert {\{ {e}_{S , i} ( n ) \}}^{p} - {\{ {e}_{S , i} ( n ) \}}^{p} \vert )}^{\frac{1}{p}} \qquad ( 1 )$$

In Equation (1), is a channel index in the dynamic compressive gammachirp filter bank 121, and p is a constant, where p=2 is used, for example. The distortion signal extracting unit 123 finds the signals in a number corresponding to the number of channels in the dynamic compressive gammachirp filter bank 121 (“I” channels), and outputs the distortion signal.

The modulation spectrum calculating unit 124 receives inputs of the amplitude envelope signal (e_{\hat{ }S, i}) corresponding to the noisy speech or the enhanced speech, and the amplitude envelope signal (e_{s, i}) corresponding to the clean speech, these amplitude envelope signals being output from the amplitude envelope signal extracting unit 122, and also receives an input of the distortion signal (e_{D, i}) found by the distortion signal extracting unit 123. The modulation spectrum calculating unit 124 calculates modulation power spectrums (E_{\hat{ }S, i}, E_{S, i}, E_{D, i}) corresponding to these signals, by applying Fourier transform to these signals.

The modulation filter bank 125 is a band-pass filter bank in a modulation frequency domain. The modulation filter bank 125 analyzes the modulation power spectrums (E_{S, i}, E_{D, i}) calculated by the modulation spectrum calculating unit 124, using the modulation filter bank (“J” channels in total). The modulation filter bank 125 is applied as the absolute value of the modulation spectrum based on a modulation frequency fₑₙᵥ. For each channel of the modulation filter bank, the modulation filter bank 125 calculates an output power spectrum P_{env, i, j} that is the clean speech or the distortion signal weighted by modulation filter bank. The output power spectrum P_{env, i, j} obtained by applying a power spectrum Wⱼ (fₑₙᵥ) of the j^{th} modulation filter {j|1≤j≤J} is found with the use of Equation (2) below.

$${P}_{env , * , i , j} = \frac{1}{{{E}_{\hat{S} , i} ( 0 )}^{2}} {\int }_{{f}_{env} > 0}^{∞} {\vert {E}_{* , i} ( {f}_{env} ) \vert}^{2} {W}_{j} ( {f}_{env} ) {df}_{env} \qquad ( 2 )$$

Where W₁ (f) is a third-order low-pass filter using a Butterworth filter (see Reference 1: “Butterworth filter”, [online], Wikipedia, [searched on Jun. 14, 2018], Internet <URL:https://ja.wikipedia.org/wiki/%E3%83%90%E3%82%BF%E3%83%BC%E3%83%AF%E3%83%BC%E3%82%B9%E3%83%95%E3%82%A3%E3%83%AB%E3%82%BF>), and a square of a transfer function for a second-order band-pass filter (LC resonance filter) may be used as W₂ (f) to Wⱼ (f) (see Reference 2: Electrical Engineering: Principles and Applications (4th Edition), by Allan R. Hambley, 2008).

The asterisk (*) in Equation (2) corresponds to the distortion signal D or the clean speech S. E^{\hat{ }S, i} (0) in Equation (2) is the power spectrum E_{\hat{ }S, i} of a zero^{th}-order component (DC component) of the amplitude envelope signal corresponding to the noisy speech or the enhanced speech, found by the modulation spectrum calculating unit 124. In the calculation of the output power spectrum representing the clean speech or the distortion signal, normalization by this zero^{th}-order component (DC component) is performed. P_{env, *, i, j} is set as P_{env, *, i, j}=max(P_{env, *, i, j}, 0.01), for example, as a minimum value, as an internal noise in the modulation frequency domain. In this embodiment, it is assumed that, as an example, the number of channels “I” in the dynamic compressive gammachirp filter bank 121 is 100, and the number of channels “J” in the modulation filter bank is 7. With these settings, the modulation filter bank 125 outputs 700 modulation power spectrums P_{env, *, i, j} in total.

The SDRₑₙᵥ calculating unit 126 calculates a signal-to-distortion ratio (SDRₑₙᵥ) between the weighted clean speech and the weighted distortion signal, as a difference component. The SDRₑₙᵥ calculating unit 126 calculates the signal-to-distortion ratio (SDRₑₙᵥ) in the modulation frequency domain, using the modulation power spectrum of the clean speech (P_{env, S}) and the modulation power spectrum of the distorted signal (P_{env, D}). As indicated by Equation (3) below, SDR_{env, j} at each modulation filter channel j is obtained based on a ratio between the sum of P_{env, s, i, j} and the sum of P_{env, D, i, j} across the entire channels of the dynamic compressive gammachirp filter.

$${SDR}_{env , j} = \frac{{\sum }_{i = 1}^{I} {P}_{env , S , i , j}}{{\sum }_{i = 1}^{I} {P}_{env , D , i , j}} \qquad ( 3 )$$

The SDRₑₙᵥ calculating unit 126 then calculates the entire SDRₑₙᵥ using Equation (4) below.

$${SDR}_{env} = \sqrt{{\sum }_{j = 1}^{J} {( {SDR}_{env , j} )}^{2}} \qquad ( 4 )$$

The sensitivity index converting unit 127 converts the value of SDRₑₙᵥ calculated by the SDRₑₙᵥ calculating unit 126 into a sensitivity index d′ corresponding to an ideal observer, using Equation (5) below. In Equation (5), “k” and “q” are parameter constants.

d′=k·(SDRₑₙᵥ)^{q} (5)

The speech intelligibility converting unit 128 receives an input of the sensitivity index d′ found by the sensitivity index converting unit 127, and converts the sensitivity index d′ to a speech intelligibility (a value between 0 and 1) using the equal-variance Gaussian model and the m-alternative forced choice (mAFC) model. In other words, the speech intelligibility converting unit 128 converts the sensitivity index d′ into a speech intelligibility by applying following Equation (6) to the sensitivity index d′, and outputs the speech intelligibility.

$${P}_{correct} ( {d}^{′} ) = Φ ( \frac{{d}^{′} - {μ}_{N}}{\sqrt{{σ}_{S}^{2} + {σ}_{N}^{2}}} ) \qquad ( 6 )$$

Where Φ is a cumulative Gaussian distribution. μ_{N} and σ_{N} are dependent on the number of alternatives m as a response, the alternatives being presumed from a speech specimen. Specifically, μ_{N} is expressed by Equation (7), and σ_{N} is expressed by Equation (8). U_{N} in Equations (7) and (8) is expressed by Equation (9)). Φ⁻¹ in Equation (9) is an inverse function of a normal cumulative distribution.

$$\begin{matrix}{μ}_{N} = {U}_{n} + \frac{0.577}{{U}_{n}} & ( 7 ) \\ {σ}_{N} = \frac{1.28255}{{U}_{n}} & ( 8 ) \\ {U}_{n} = {Φ}^{- 1} ( 1 - \frac{1}{m} ) & ( 9 )\end{matrix}$$

σₛ is a parameter that is assumed to be associated with redundancy in a speech specimen. σₛ is smaller when the speech is a simple sentence that makes sense, and σₛ is greater when the speech is a single-syllable speech without any redundancy. Specific settings of σₛ will be described later.

The speech intelligibility output unit 129 outputs the speech intelligibility calculated by the speech intelligibility converting unit 128 to the external. The speech intelligibility output unit 129 is a communication interface, for example, and outputs the speech intelligibility to the external over a network, for example. Alternatively, the speech intelligibility output unit 129 stores the speech intelligibility in a storage medium. The speech intelligibility output unit 129 may also be a liquid-crystal display or a printer, for example.

[Process Performed by GEDI Speech Intelligibility Calculating Apparatus]

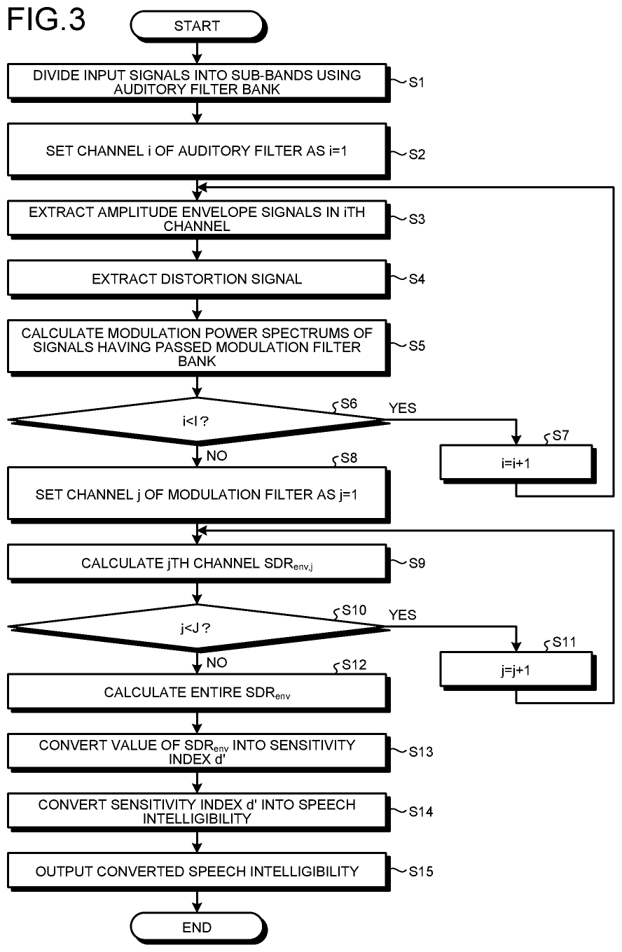

A process performed by the GEDI speech intelligibility calculating apparatus 12 illustrated in FIG. 2 will now be explained. FIG. 3 is a flowchart illustrating the sequence of the speech intelligibility calculating process according to the embodiment.

To begin with, the GEDI speech intelligibility calculating apparatus 12 receives an enhanced speech or a noisy speech (\hat{ }S) for which a speech intelligibility is to be predicted, and a clean speech (S) as input signals, and divides the input signals into sub-bands using the dynamic compressive gammachirp filter bank 121 that is an auditory filter bank (Step S1). The GEDI speech intelligibility calculating apparatus 12 then sets the channel i of the auditory filter as i=1 (Step S2).

The amplitude envelope signal extracting unit 122 then extracts an amplitude envelope signal e_{\hat{ }S, i} (n) corresponding to the noisy speech or the enhanced speech, and an amplitude envelope signal e_{S, i} (n) corresponding to the clean speech, in the i^{th} channel (Step S3). The distortion signal extracting unit 123 then receives inputs of the i^{th} channel amplitude envelope signals (e_{\hat{ }S, i} (n), e_{S, i} (n)), and extracts a temporal distortion signal (e_{D}), using Equation (1) (Step S4). From the modulation power spectrums (E_{\hat{ }S, i}, E_{S, i}, e_{D, i}) calculated by the modulation spectrum calculating unit 124, the modulation filter bank 125 then calculates modulation power spectrums P_{env, i, j} of the signals having passed the modulation filter bank, using Equation (2) (Step S5).

The GEDI speech intelligibility calculating apparatus 12 then determines whether i<I is established (Step S6). If it is determined that i<I is established (Yes at Step S6), the GEDI speech intelligibility calculating apparatus 12 sets i=i+1 (Step S7). The system control goes back to Step S3, and the extraction of the amplitude envelope signals in the next i^{th} channel is then performed. If the GEDI speech intelligibility calculating apparatus 12 determines that i<I is not established (No at Step S6), the channel j of the modulation filter is set as j=1 (Step S8).

The SDRₑₙᵥ calculating unit 126 then calculates the j^{th} channel SDR_{env, j}, using Equation (3), based on the modulation power spectrum (P_{env, S}) of the clean speech and the modulation power spectrum (P_{env, D}) of the distortion signal (Step S9). The SDRₑₙᵥ calculating unit 126 then determines whether j<J is established (Step S10). If it is determined that j<J is established (Yes at Step S10), the SDRₑₙᵥ calculating unit 126 sets j=j+1 (Step S11). The system control then goes back to Step S9, and the SDRₑₙᵥ in the next j^{th} channel is calculated.

If it is determined that j<J is not established (No at Step S10), the SDRₑₙᵥ calculating unit 126 calculates the entire SDRₑₙᵥ using Equation (4) (Step S12). The sensitivity index converting unit 127 then converts the value of SDRₑₙᵥ into a sensitivity index d′, using Equation (5) (Step S13). The speech intelligibility converting unit 128 then converts the sensitivity index d′ into a speech intelligibility using the equal-variance Gaussian model and the mAFC model (Step S14). The speech intelligibility output unit 129 then outputs the converted speech intelligibility (Step S15), and the process is ended.

[Listening Experiment]

Using the technique disclosed in the embodiment, a listening experiment was carried out. Speech intelligibility assessments were made using the spectrum subtraction (SS) and Wiener filter-based noise reduction (WF). The 4-mora word speeches uttered by male speakers (mis), and recorded in the Familiarity-controlled Word-lists (FW07) were used as the speech specimens. Pink noise was then superimposed over the speech specimen as the noise, while changing the signal-to-noise ratio (SNR) at an increment of 3 dB within the range between −6 dB and 3 dB. The speech enhancement processes described above were then applied to the noise-superimposed speeches as the original speeches (hereinafter, referred to as “unprocessed”). Four hundred speech stimuli were presented in total, including those in five different conditions (unprocessed, SS^{(1, 0)}, WF^{(0, 0)}_{PSM}, WF^{(0, 1)}_{PSM}, WF^{(0, 2)}_{PSM}) and having four different SNRs (−6, −3, 0, 3 dB).

In this listening experiment, four male and five female subjects with normal hearing at the age from 20 to 23 participated. The speech stimuli were then randomly presented to the experiment participants, and the experiment participants wrote down the 4-mora speeches they heard on the answer sheet in Hiragana. In this experiment, only the complete match was considered as a correct answer, and the speech intelligibility was calculated as a percentage at the end. Every experiment participant was confirmed to have healthy hearing capability, using an audiogram within the range of 125 Hz and 8000 Hz. Prior to the experiment, an informed consent about this listening experiment was obtained from each participant.

In order to examine whether the technique according to the embodiment (GEDI) was capable of predicting the result of the listening experiment correctly, a different speech set was prepared for each subject, and the GEDI calculated the speech intelligibility for the speech data set. Among the GEDI parameters, the number of response alternatives was set to m=20000, considering an estimation of the mental lexicon size corresponding to FW07 and low familiarity of the speech specimen used in this experiment. As a result of carrying out fitting in such a manner that the mean-squared errors (MSE) of the predicted speech intelligibilities (“unprocessed”) with respect to the listening experiment results were minimized, the remaining parameters were established as k=1.17, σₛ=1.62.

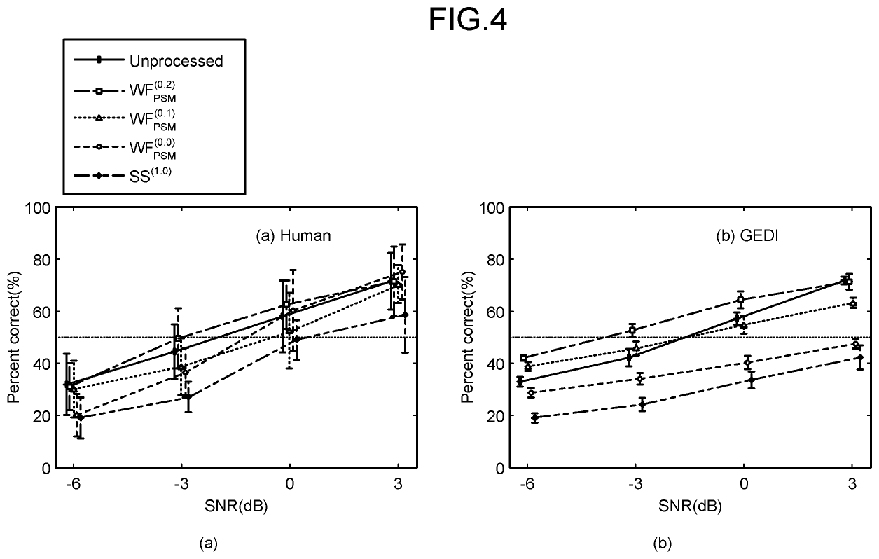

FIG. 4 is a schematic illustrating the results of the listening experiment, and the prediction results achieved by the GEDI speech intelligibility prediction method. FIG. 4(a) illustrates the results of the listening experiment. FIG. 4(b) illustrates the prediction results achieved by the GEDI speech intelligibility prediction method. The horizontal axis represents the SNR in the “unprocessed” (the noise-superimposed speeches before the noise reduction processing is applied). The results of the listening experiment and those achieved by the GEDI include five curves, four of which correspond to the four types of noise reduction processing (spectrum subtraction) (SS^{(1,0)}), and Wiener filter-based noise reductions WF^{(0, 0)}_{PSM}, WF^{(0, 1)}_{PSM}, WF^{(0, 2)}_{PSM}), and the remaining one of which corresponds to “unprocessed”.

The plot in FIG. 4(a) represents the average of results found from the nine subjects, and the plot in FIG. 4(b) represents the average of the speech intelligibility predictions calculated by the GEDI for the entire set of data used in each type of the listening experiment. The vertical bars in the plot represent standard deviations.

In the results of the listening experiment (FIG. 4(a)), the speech intelligibility curve of WF^{(0,2)}_{PSM} exhibited higher correctness than that of “unprocessed”. In the results of the listening experiment (FIG. 4(a)), by contrast, the speech intelligibility curves of WF^{(0, 1)}_{PSM} and SS^{(1, 0)} exhibited lower correctness than that of “unprocessed”. The speech intelligibility curve WF^{(0, 0)}_{PSM} was higher than that of “unprocessed” when the SNR was higher, and was lower than that of “unprocessed” when the SNR was lower. Based on these results, the perceptual assessments by the listening experiment suggests that the noise reduction WF^{(0, 2)}_{PSM} successfully improved the speech intelligibilities of the noise-superimposed speeches.

The GEDI that is the technique according to the embodiment made speech intelligibility predictions (FIG. 4(b)) near the results obtained by the listening experiment (FIG. 4(a)). In other words, the speech intelligibility prediction results of the GEDI obtained for the all of the noise reductions were plotted in the order of WF^{(0, 2)}_{PSM}>WF^{(0, 1)}_{PSM}>WF^{(0, 0)}_{PSM}>SS^{(1, 0)}, and these curves exhibited almost parallel positional relations. In the results of the speech intelligibility prediction performed by the GEDI, the speech intelligibility curve of WF^{(0, 2)}_{PSM} was plotted higher than unprocessed, in the same manner as in the listening experiment. In this manner, it can be seen that, among the noise reduction processing subjected to this experiment, WF^{(0, 2)} exerted the highest noise reduction performance. In the results of the speech intelligibility prediction performed by the GEDI, SS^{(1, 0)} always exhibited the lowest performance, than those achieved under any other processing conditions.

In the manner described above, because the results of the speech intelligibility prediction performed by the GEDI indicated an extremely high correlation with the results of the listening experiment, it can be concluded that the GEDI has calculated the speech intelligibility highly accurately.

[Advantageous Effects Achieved by Embodiment]

In the manner described above, the GEDI speech intelligibility calculating apparatus according to the embodiment estimates a distortion component (e_{D}) included in an enhanced speech, based on a difference between the temporal amplitude envelope signal of the clean speech and the temporal amplitude envelope signal of the enhanced speech, and calculates SDRₑₙᵥ that is used as the basis for calculating a speech intelligibility that is an objective assessment index of a speech quality, using the features of the distortion component and of the clean speech.

The GEDI speech intelligibility calculating apparatus 12 receives an input of a clean speech before the noise superimposition. Therefore, the enhancement processing apparatus 11 positioned at a stage preceding the GEDI speech intelligibility calculating apparatus 12 does not need to calculate a residual noise component, and to input the residual noise component to the GEDI speech intelligibility calculating apparatus 12. In other words, it is not necessary to calculate the residual noise component, which has been required for the conventional assessment index (sEPSM, dcGC-sEPSM). Therefore, the enhancement processing apparatus 11 can be applied to any speech enhancement technique, and calculate a speech intelligibility without any dependency on a speech enhancement technique. In other words, compared with the conventional sEPSM and dcGC-sEPSM, it is not necessary to perform an estimating process that is dependent on the speech enhancement processing, so that a highly convenient object assessment index calculation can be achieved.

The GEDI speech intelligibility calculating apparatus 12 uses the dynamic compressive gammachirp filter bank (dcGC) as the auditory filter bank, in the same manner as dcGC-sEPSM does. The dcGC-sEPSM is capable of reflecting the features of hearing-impaired persons as well as the features of hearing persons. Therefore, with this embodiment, the gammachirp filter bank parameters found from audiometry can be introduced directly to reflect the features of hearing-impaired persons, so that the GEDI speech intelligibility calculating apparatus 12 according to the embodiment can be applied to the speech intelligibility estimation for hearing-impaired persons.

The GEDI speech intelligibility calculating apparatus 12 can also predict the intelligibility of an enhanced speech more accurately than the conventional sEPSM and dcGC-sEPSM have capable of, even when used is a speech enhancement technique for which there is no clear definition of the residual component, e.g., the latest Wiener filter-base noise reduction. Furthermore, as indicated by the experiment, by predicting and comparing speech intelligibilities for a plurality of different speech enhancement techniques using the technique according to the embodiment, the speech enhancement techniques can be assessed, and a better speech enhancement technique can be selected, more accurately.

In the manner described above, with the embodiment, it is possible to achieve a speech intelligibility calculation without any dependency on a speech enhancement method, and the technique according to the embodiment can be used as a speech intelligibility calculation method for both of hearing persons and hearing aids.

### First Modification of Embodiment

A first modification of the embodiment will now be explained. In the first modification, another example of the method for calculating SDRₑₙᵥ will be explained.

In the first modification, SDRₑₙᵥ is weighted appropriately. In the first modification, a more robust speech intelligibility estimation method is achieved by calculating SDRₑₙᵥ by weighing P_{env, *, i, j} (where the asterisk (*) is the distortion signal D or the clean speech (S)) appropriately.

In the first modification, the SDRₑₙᵥ calculating unit 126 performs the calculation at Step S9 by giving a weight Vᵢ to the dynamic compressive gammachirp filter in each channel i, as indicated by Equation (10) below.

$${SDR}_{env , j} = \frac{{\sum }_{i = 1}^{I} {V}_{i} {P}_{env , S , i , j}}{{\sum }_{i = 1}^{I} {V}_{i} {P}_{env , D , i , j}} \qquad ( 10 )$$

As the weight, Vᵢ indicated in Equation (11) below may be used, for example.

$${V}_{i} = \frac{{ERB}_{N} ( {f}_{0} )}{{ERB}_{N} ( {f}_{i} )} \qquad ( 11 )$$

Where ERB_{N} (f) is an equivalent rectangular bandwidth at a frequency f (Hz) (see Reference 3: B. C. J. Moore, “Chapter 3: Frequency Selectivity, Masking, and the Critical Band”, in An Introduction to the Psychology of Hearing, Sixth Edition, Brill, pp. 67-132, 2013, for example), and f0 is set to 1000 (Hz), for example.

As the weight Vᵢ, it is also possible to use any appropriate weight with which the bandwidth of the auditory filter can be corrected, instead of that indicated in Equation (11).

In the first modification, the same process as that illustrated in FIG. 3 is performed except for the process at Step S9 performed by the SDRₑₙᵥ calculating unit 126.

### Second Modification of Embodiment

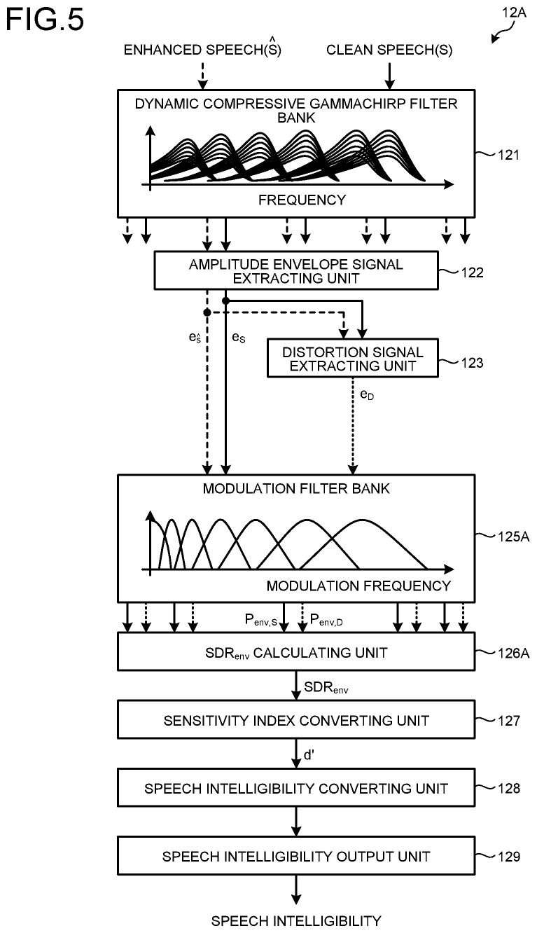

A second modification of the embodiment will now be explained. According to the second modification, a more robust speech intelligibility estimation method is achieved when the noise is non-stationary noise. FIG. 5 is a schematic giving a schematic representation of functions of the GEDI speech intelligibility calculating apparatus according to the second modification of the embodiment.

As illustrated in FIG. 5, this GEDI speech intelligibility calculating apparatus 12A according to the second modification of the embodiment has a configuration in which the modulation spectrum calculating unit 124 is omitted, compared with the GEDI speech intelligibility calculating apparatus 12 illustrated in FIG. 2. The GEDI speech intelligibility calculating apparatus 12A includes a modulation filter bank 125A (second filter bank) and an SDRₑₙᵥ calculating unit 126A, instead of the modulation filter bank 125 and the SDRₑₙᵥ calculating unit 126, compared with the GEDI speech intelligibility calculating apparatus 12.

The modulation filter bank 125A receives inputs of the temporal amplitude envelope signal e_{\hat{ }S, i} (n) corresponding to the noisy speech or the enhanced speech and the temporal amplitude envelope signal e_{S, i} (n) corresponding to the clean speech, these temporal amplitude envelopes being output from the amplitude envelope signal extracting unit 122, and the distortion signal e_{D, i} (n) found by the distortion signal extracting unit 123.

To begin with, the modulation filter bank 125A inputs the amplitude envelope signal e_{S, i} (n) and the distortion signal e_{D, i} (n) to the modulation filter bank, and calculates output time series E_{S, i, j} (n) and E_{D, i, j} (n) of the j^{th} modulation filter. Used as the modulation filter bank herein are LPF using a third-order Butterworth filter, and a plurality of second-order band-pass filters, for example.

The modulation filter bank 125A then divides the output time series E_{s, i, j} (n) and E_{D, i, j} (n) into units in a short-time frame, and finds the divided time series in a t^{th} frame on each channel j as E_{s, i, j, t}(n) and E_{D, i, j, t}(n), respectively. The length of the short-time frame is set to the inverse of a cutoff frequency (LPF) or a center frequency (BPF) of the modulation filter bank, for example, and the frame overlap is set to a value between zero and the short-time frame length.

The modulation filter bank 125A then calculates the modulation power spectrum related to each j, using Equation (12), as an output from the modulation filter bank 125A.

$${P}_{env , * , i , j , t} = \frac{1}{{Av [ {e}_{\hat{S} , i} ( n ) ]}_{n}^{2} \text{/} 2} {Av [ {( {E}_{* i , j , t} ( n ) - {Av [ {E}_{* , i , j , t} ( n ) ]}_{n} )}^{2} ]}_{n} \qquad ( 12 )$$

In Equation (12), the asterisk (*) is the distortion signal D or the clean speech (S), and Av[f(n)]ₙ denotes an average-calculating operation related to n in f(n).

The SDRₑₙᵥ calculating unit 126A then calculates signal-to-distortion ratio SDRₑₙᵥ in the modulation frequency domain, for each of the short-time frames t, based on Equation (13), using the modulation power spectrum P_{env, S, i, j, t} of the clean speech, and the modulation power spectrum P_{env, D, i, j, t} of the distortion signal, as inputs.

$${SDR}_{env , j , t} = \frac{{\sum }_{i = 1}^{I} {P}_{env , S , i , j , t}}{{\sum }_{i = 1}^{I} {P}_{env , D , i , j , t}} \qquad ( 13 )$$

Alternatively, the SDRₑₙᵥ calculating unit 126A may also calculate the signal-to-distortion ratio SDRₑₙᵥ with Equation (14) in which the weight Vᵢ is used, in the same manner as in the first modification of the embodiment.

$${SDR}_{env , j , t} = \frac{{\sum }_{i = 1}^{I} {V}_{i} {P}_{env , S , i , j , t}}{{\sum }_{i = 1}^{I} {V}_{i} {P}_{env , D , i , j , t}} \qquad ( 14 )$$

The SDRₑₙᵥ calculating unit 126A then calculates the entire SDRₑₙᵥ using the SDR_{env, j, t}, based on Equation (15) and Equation (16), and outputs the result.

$$\begin{matrix}{SDR}_{env , j} = \frac{1}{{T}_{j}} {\sum }_{t = 1}^{{T}_{i}} {SDR}_{env , j , t} & ( 15 ) \\ {SDR}_{env} = \sqrt{{\sum }_{j = 1}^{J} {SDR}_{env , j}^{2}} & ( 16 )\end{matrix}$$

Where Tⱼ is the number of the short-time frames in the j^{th} modulation filter, and this value is uniquely determined by the length of the short-time frame and the length of the input data.

[Process Performed by GEDI Speech Intelligibility Calculating Apparatus]

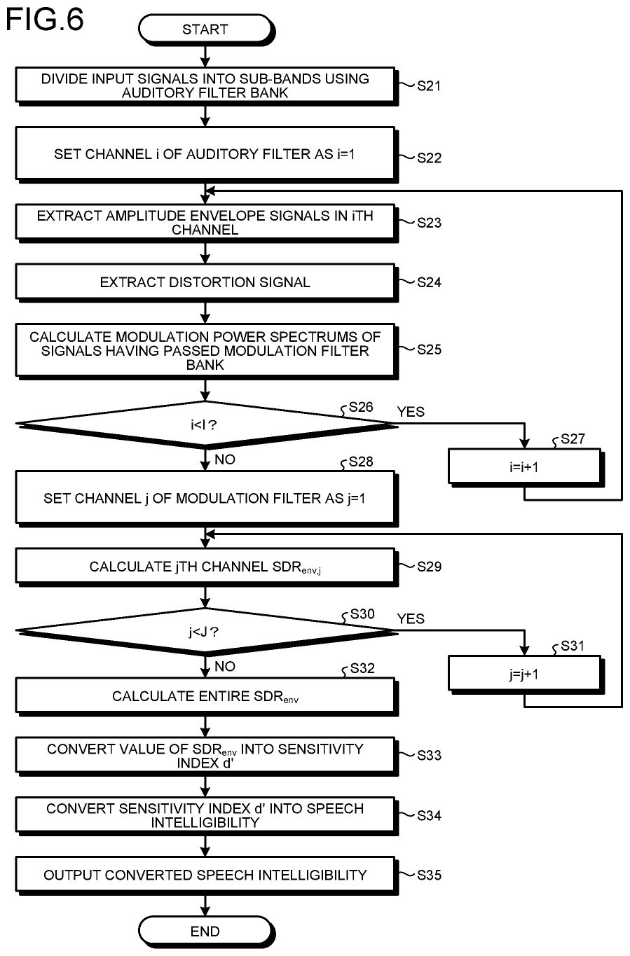

A process performed by the GEDI speech intelligibility calculating apparatus 12A illustrated in FIG. 5 will now be explained. FIG. 6 is a flowchart illustrating the sequence of a speech intelligibility calculating process according to the second modification of the embodiment.

Steps S21 to S24 illustrated in FIG. 6 are the same as Steps S1 to S4 illustrated in FIG. 3.

The modulation filter bank 125A receives inputs of the amplitude envelope signal e_{\hat{ }S, i} (n) corresponding to the noisy speech or the enhanced speech, the amplitude envelope signal e_{S, i} (n) corresponding to the clean speech, these amplitude envelope signals being output from the amplitude envelope signal extracting unit 122, and the distortion signal e_{D, i} (n) found by the distortion signal extracting unit 123, and calculates the modulation power spectrum of the signals having passed the modulation filter bank (Step S25). Specifically, the modulation filter bank 125A receives inputs of the amplitude envelope signal E_{\hat{ }S, i} (n) corresponding to the noisy speech or the enhanced speech and the amplitude envelope signal e_{S, i} (n) corresponding to the clean speech, these amplitude envelope signals being output from the amplitude envelope signal extracting unit 122, and the distortion signal e_{D, i} (n) found by the distortion signal extracting unit 123, calculates the modulation power spectrum P_{env, S, i, j, t} of the clean speech and the modulation power spectrum P_{env, D, i, j, t} of the distortion signal, using Equation (12).

Steps S26 to S28 illustrated in FIG. 6 are the same as Steps S6 to S8 illustrated in FIG. 3.

The SDRₑₙᵥ calculating unit 126A calculates SDRₑₙᵥ using the modulation power spectrum P_{env, S, i, j, t} of the clean speech and the modulation power spectrum P_{env, D, i, j, t} of the distortion signal, as a difference component (Step S29). At this time, the SDRₑₙᵥ calculating unit 126A uses one of Equation (13) and Equation (14), and one of Equation (15) and Equation (16).

Steps S30 to S35 illustrated in FIG. 6 are the same as Step S10 to Step S15 illustrated in FIG. 3.

By performing the process according to the second modification of the embodiment, the modulation spectrum calculating unit 124 can be omitted in the GEDI speech intelligibility calculating apparatus 12A.

[System Configuration, Etc.]

The elements included in the apparatuses illustrated in the drawings are merely functional and conceptual representations, and do not necessarily need to be configured physically as illustrated in the drawings. In other words, the specific configurations in which the apparatuses are distributed or integrated are not limited to those illustrated, and the whole or a part thereof may be distributed or integrated into any units, either functionally or physically, depending on various load or utilization conditions. Furthermore, the whole or any part of the processing functions executed in each of the apparatuses may be implemented as a CPU and a computer program parsed and executed by the CPU, or hardware using wired logics.

Furthermore, among the processes explained in the embodiment, those explained to be performed automatically may be performed manually, entirely or partly, or those explained to be performed manually may be performed automatically, entirely or partly, using any known method. In addition, information including the sequences of processing, the sequences of control, specific names, various data, and parameters mentioned in the above description or the drawings may be changed in any way, unless specified otherwise.

[Computer Program]

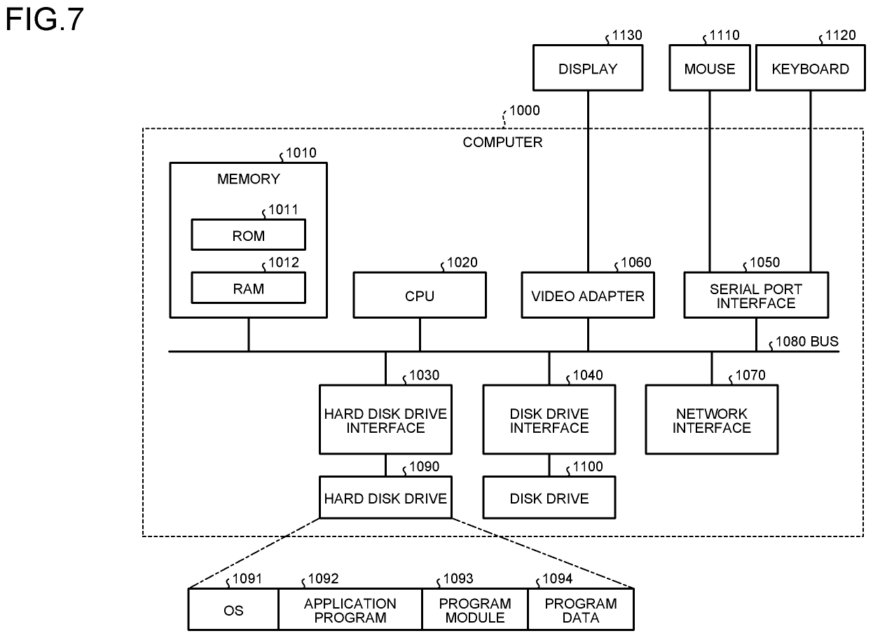

FIG. 7 is a schematic illustrating one example of a computer implementing the GEDI speech intelligibility calculating apparatus 12 by executing a computer program. This computer 1000 includes a memory 1010 and a CPU 1020, for example. The computer 1000 also includes a hard disk drive interface 1030, a disk drive interface 1040, a serial port interface 1050, a video adapter 1060, and a network interface 1070. These units are connected to one another via a bus 1080.

The memory 1010 includes a read-only memory (ROM) 1011 and a random access memory (RAM) 1012. The ROM 1011 stores therein a boot program such as Basic Input Output System (BIOS). The hard disk drive interface 1030 is connected to a hard disk drive 1090. The disk drive interface 1040 is connected to a disk drive 1100. A removable storage medium such as a magnetic disk or an optical disc is inserted into the disk drive 1100. The serial port interface 1050 is connected to a mouse 1110 or a keyboard 1120, for example. The video adapter 1060 is connected to a display 1130, for example.

The hard disk drive 1090 stores therein, for example, an operating system (OS) 1091, an application program 1092, a program module 1093, and program data 1094. In other words, the computer program describing each of the process performed by the GEDI speech intelligibility calculating apparatus 12 is implemented as the program module 1093 in which a computer-executable code is described. The program module 1093 is stored in the hard disk drive 1090, for example. For example, the program module 1093 for executing the same processes as those performed by the functional configurations in the GEDI speech intelligibility calculating apparatus 12 is stored in the hard disk drive 1090. The hard disk drive 1090 may be replaced with a solid state drive (SSD).

Furthermore, setting data used in the processes described in the embodiment is stored in the memory 1010 or the hard disk drive 1090, for example, as the program data 1094. The CPU 1020 then reads the program module 1093 or the program data 1094 stored in the memory 1010 or the hard disk drive 1090 onto the RAM 1012, as required, and executes the items read out.

The storage of the program module 1093 or the program data 1094 is not limited to the hard disk drive 1090, and may be also stored in a removable storage medium, for example, and may be read by the CPU 1020 via the disk drive 1100, for example. Alternatively, the program module 1093 and the program data 1094 may be stored in another computer connected to a network (such as a local area network (LAN) or a wide area network (WAN)). The CPU 1020 may then read the program module 1093 and the program data 1094 from the other computer via the network interface 1070.

An embodiment that is an application of the invention made by the inventors has been explained above, but none of the descriptions and the drawings making up a part of the disclosure of the embodiment of the present invention is intended to limit the scope of the present invention in any way. In other words, any other embodiments, operation technologies, and the like that are implemented based on the embodiment by those skilled in the art or the like all fall within the scope of the present invention.

### REFERENCE SIGNS LIST

11, 11P enhancement processing apparatus

12, 12A GEDI speech intelligibility calculating apparatus

12P speech intelligibility calculating apparatus

121 dynamic compressive gammachirp filter bank

122 amplitude envelope signal extracting unit

123 distortion signal extracting unit

124 modulation spectrum calculating unit

125, 125A modulation filter bank

126, 126A SDRₑₙᵥ calculating unit

127 sensitivity index converting unit

128 speech intelligibility converting unit

129 speech intelligibility output unit

1. A speech intelligibility calculating method executed by a speech intelligibility calculating apparatus, the speech intelligibility calculating method comprising:
a speech intelligibility calculating step of finding a feature of an input clean speech and a feature of an input enhanced speech using a plurality of filter banks, and of calculating a speech intelligibility that is an objective assessment index of a speech quality, based on a difference component between the found feature of the clean speech and the feature of the enhanced speech; and
a step of outputting the speech intelligibility calculated at the speech intelligibility calculating step.

2. The speech intelligibility calculating method according to claim 1, wherein
the speech intelligibility calculating step further comprises:
a step of finding a temporal distortion signal based on the feature of the clean speech and the feature of the enhanced speech; and
a step of calculating a signal-to-distortion ratio (SDR) of the clean speech and the distortion signal based on the distortion signal and the clean speech.

3. The speech intelligibility calculating method according to claim 1, wherein
the speech intelligibility calculating step further comprises:
a step of extracting a temporal distortion signal based on a difference between temporal amplitude envelope signals of the feature of the clean speech and of the feature of the enhanced speech that are based on a first filter bank;
a step of calculating a modulation power spectrum corresponding to the clean speech and a modulation power spectrum corresponding to the distortion signal, using a second filter bank, based on the temporal amplitude envelope signal of the clean speech, the temporal amplitude envelope signal of the enhanced speech, and the temporal distortion signal; and
a step of calculating a signal-to-distortion ratio (SDR) between the clean speech and the distortion signal, as the difference component, based on the modulation power spectrum corresponding to the clean speech and the modulation power spectrum corresponding to the distortion signal.

4. The speech intelligibility calculating method according to claim 1, wherein
the speech intelligibility calculating step further comprising:
a step of extracting a temporal distortion signal based on a difference between temporal amplitude envelope signals of the feature of the clean speech and of the feature of the enhanced speech that are based on a first filter bank; and
a step of applying Fourier transform to the temporal amplitude envelope signal of the clean speech and to the temporal distortion signal to calculate a modulation power spectrum corresponding to the temporal amplitude envelope signal and a modulation power spectrum corresponding to the temporal distortion signal;
a step of weighting the modulation power spectrum of the clean speech and the modulation power spectrum of the distortion signal, using a second filter bank; and
a step of calculating a signal-to-distortion ratio (SDR) between the weighted clean speech and the weighted distortion signal, as the difference component.

5. The speech intelligibility calculating method according to claim 3, further comprising a step of calculating temporal amplitude envelope signals of the feature of the clean speech and the feature of the enhanced speech, using amplitude envelope information output from the first filter bank.

6. The speech intelligibility calculating method according to claim 3, wherein the first filter bank is a dynamic compressive gammachirp filter bank.

7. The speech intelligibility calculating method according to claim 3, wherein the second filter bank is a band-pass filter bank in a modulation frequency domain.

8. A speech intelligibility calculating apparatus comprising:
a memory; and
a processor coupled to the memory and programmed to execute a process comprising:
first finding a feature of an input clean speech and a feature of an input enhanced speech using a plurality of filter banks, and calculating a speech intelligibility that is an objective assessment index of a speech quality, based on a difference component between the found feature of the clean speech and the feature of the enhanced speech; and
outputting the speech intelligibility calculated in the first calculating.

9. The speech intelligibility calculating apparatus according to claim 8, wherein the first finding comprises:
second finding a temporal distortion signal based on a feature of the clean speech and a feature of the enhanced speech; and
first calculating a signal-to-distortion ratio (SDR) between the clean speech and the distortion signal based on the distortion signal and the clean speech.

10. The speech intelligibility calculating apparatus according to claim 8, wherein the first finding comprises:
extracting a temporal distortion signal based on a difference between temporal amplitude envelope signals of a feature of the clean speech and of a feature of the enhanced speech that are based on a first filter bank;
a second filter bank that calculates a modulation power spectrum corresponding to the clean speech and a modulation power spectrum corresponding to the distortion signal, based on the temporal amplitude envelope signal of the clean speech, the temporal amplitude envelope signal of the enhanced speech, and the temporal distortion signal; and
first calculating an SDR between the clean speech and the distortion signal, as the difference component, based on the modulation power spectrum corresponding to the clean speech and the modulation power spectrum corresponding to the distortion signal.

11. The speech intelligibility calculating apparatus according to claim 8, wherein the first finding comprises:
extracting a distortion signal included in the enhanced speech, based on temporal amplitude envelope signals of a feature of the clean speech and a feature of the enhanced speech that are based on a first filter bank;
a second filter bank that weights the clean speech and the distortion signal, using the temporal amplitude envelope signal of the clean speech, the temporal amplitude envelope signal of the enhanced speech, and the distortion signal; and
first calculating a signal-to-distortion ratio (SDR) between the weighted clean speech and the weighted distortion signal, as the difference component of the features.

12. The speech intelligibility calculating apparatus according to claim 10, further comprising:
second calculating temporal amplitude envelope signals of a feature of the clean speech and a feature of the enhanced speech using amplitude envelope information output from the first filter bank.

13. The speech intelligibility calculating apparatus according to claim 10, wherein the first filter bank is a dynamic compressive gammachirp filter bank.

14. The speech intelligibility calculating apparatus according to claim 10, wherein the second filter bank is a band-pass filter bank in a modulation frequency domain.

15. (canceled)

16. The speech intelligibility calculating method according to claim 1, wherein
the speech intelligibility calculating step further comprises:
a step of finding a temporal distortion signal based on a difference between temporal amplitude envelope signals of the feature of the clean speech and of the feature of the enhanced speech; and
a step of calculating a signal-to-distortion ratio (SDR) between the clean speech and the distortion signal, as the difference component, based on the temporal amplitude envelope signals of the clean speech and the distortion signal.

17. The speech intelligibility calculating method according to claim 1, wherein
the speech intelligibility calculating step further comprises:
a step of finding a temporal distortion signal based on the feature of the clean speech and the feature of the enhanced speech; and
a step of calculating a signal-to-distortion ratio (SDR) between the clean speech and the distortion signal, as the difference component, based on a modulation power spectrum obtained from the distortion signal and a modulation power spectrum obtained from the clean speech.

18. The speech intelligibility calculating apparatus according to claim 8, wherein the first finding further comprises:
second finding a temporal amplitude envelope signal based on a difference between temporal amplitude envelope signals of the feature of the clean speech and the feature of the enhanced speech; and
first calculating a signal-to-distortion ratio (SDR) between the clean speech and the distortion signal, as the difference component, based on the temporal amplitude envelope signal of the clean speech and the distortion signal.

19. The speech intelligibility calculating apparatus according to claim 8, wherein the first finding further comprises:
second finding a temporal distortion signal based on the feature of the clean speech and the feature of the enhanced speech; and
first calculating a signal-to-distortion ratio (SDR) between the clean speech and the distortion signal, as the difference component, based on a modulation power spectrum obtained from the distortion signal and a modulation power spectrum obtained from the clean speech.

20. The speech intelligibility calculating apparatus according to claim 11, further comprising:
second calculating temporal amplitude envelope signals of a feature of the clean speech and a feature of the enhanced speech using amplitude envelope information output from the first filter bank.

21. The speech intelligibility calculating apparatus according to claim 11, wherein the first filter bank is a dynamic compressive gammachirp filter bank.

22. The speech intelligibility calculating apparatus according to claim 11, wherein the second filter bank is a band-pass filter bank in a modulation frequency domain.

23. A computer-readable recording medium having stored therein a speech intelligibility calculating program for causing a computer to execute a process comprising:
a speech intelligibility calculating step of finding a feature of an input clean speech and a feature of an input enhanced speech using a plurality of filter banks, and of calculating a speech intelligibility that is an objective assessment index of a speech quality, based on a difference component between the found feature of the clean speech and the feature of the enhanced speech; and
a step of outputting the speech intelligibility calculated at the speech intelligibility calculating step.
